(19) United States
(12) Patent Application Publication
(10) Pub. No.: US 2007/0066475 A1
(43) Pub. Date: Mar. 22, 2007

(54) Envelope gum detection

(75) Inventor: Verner F. Clark JR., Kennesaw, GA (US)

Correspondence Address: FULBRIGHT AND JAWORSKI LLP, 555 S. FLOWER STREET, 41ST FLOOR, LOS ANGELES, CA, 90071, US

(73) Assignee: National Envelope Corporation

(21) Appl. No.: 11/522,017

(22) Filed: Sep. 15, 2006

Related U.S. Application Data
(60) Provisional application No. 60/596,325, filed on Sep. 16, 2005.

(51) Int. Cl. B31B 1/00

(52) U.S. Cl. 493/917; 493/2

(57) ABSTRACT

Two sensors and an Operator Interface are mounted on an envelope machine inline after the side seam gumming system. As the envelope under the sensors, they measure the luminance/reflectivity of a certain spot on the envelope where the side seam gum should be located. The reflectivity of the side seam gum will be different than that of the envelope paper. If the reflectivity measurement at that position is within the preset values in the device, the envelope is within the specification and nothing happens; the envelope continues through the machine. If the measurement does not meet the values in the device, the envelope is out of specification, and an output signal is returned. That output signal may be used for any purpose, but most commonly activates a red light, or marks the envelopes as defective.

### RELATED APPLICATION

This application claims the benefit of the prior filing date of U.S. Patent Application No. 60/596,325 filed Sep. 16, 2005 for Side Seam Gumming Detection, incorporated herein by reference in its entirety.

### BACKGROUND OF THE INVENTION

1. Field of the Invention

This invention relates generally to the manufacture of envelopes on a production line manufacturing apparatus and more particularly to an apparatus and method for detecting the presence of gum at predetermined positions upon the envelope

2. Description of the Prior Art

Envelope manufacturing machines which fold the closure, side and bottom flaps of envelope blanks are well known in the prior art. Such machines which manufacture such envelopes on a production line basis are also well known, including such apparatus which automatically applies gum to predetermined portions of the envelope blank during the manufacturing process.

While it is known to make envelopes and apply adhesives to various flaps of the envelopes in a continuous production line system, if the gum is incorrectly applied to the predetermined areas of the envelope, then the envelope will not function as designed. Such will in turn negatively affect the basic use of the envelope as well as causing problems with inserting equipment and postal sorting equipment. Traditional ways to validate the correct positioning of gum at predetermined points on the envelope blank have been visual inspection, holding the envelope to a template or the like. Such methods only validate a very small percentage of envelopes at a time and are not capable of being used inline on high speed production envelope manufacturing apparatus so that every envelope produced is validated thus eliminating human operator input and use thereby eliminating a possible source of error.

There is thus need for an apparatus and process which may be utilized inline on high speed envelope production equipment for the detecting the gum at predetermined positions on an envelope blank during the production process to validate that the gum exists and is in the proper position and length.

### SUMMARY OF THE INVENTION

The present invention is directed to a method for detecting the presence of gum on an envelope including directing a source of radiation toward an envelope in the area where gum should be present, sensing the reflectivity of the radiation from the envelope, comparing the sensed reflectivity to a predetermined desired reflectivity from the gum deposited on the envelope and providing an out of specification indicia only when the sensed reflectivity is outside the predetermined desired reflectivity.

The invention also is directed to an apparatus for detecting the presence of gum on an envelope which includes a source of radiation, a sensor for detecting the reflectivity of the radiation from the envelope, a means for comparing the sensed reflectivity to a predetermined desired reflectivity from the gum deposited on the envelope and means for providing an out of specification indicia only when the sensed reflectivity is outside the predetermined desired reflectivity.

### BRIEF DESCRIPTION OF THE DRAWINGS

FIG. 1 is a schematic representation of an envelope to be manufactured in accordance with the principles of the present invention;

FIG. 2 is a schematic diagram of a sensor positioned adjacent an envelope which has been gummed;

FIG. 3 is a schematic representation of a portion of an envelope manufacturing apparatus which is utilized to detect the presence of gum on the envelope as depicted in FIG. 1;

FIG. 4 is a schematic representation of mounting brackets for the sensor of FIG. 2; and

FIG. 5 is a schematic representation of an operator interface control panel for a programmable logic controller for the apparatus as depicted in FIG. 3.

### DETAILED DESCRIPTION

The present invention is directed to a process and apparatus to detect the location and presence of gum on an envelope as it is being manufactured on a high speed production machinery. More particularly, in a preferred embodiment of the present invention the presence of the gum is detected on a side seam envelope and the process occurs inline with the manufacturing process and detects the location and presence of side seam gum for both sides of every envelope produced. Preferably, the process and apparatus uses a housing which packages a radiation source and a sensor to detect the radiation emanating from that source as it is reflected from the surface of the envelope. A housing is disposed on each side of the inline through which the side seam envelope moves in the manufacturing machine. Each of the sensors is coupled to a programmable logic controller (PLC) to control the apparatus. The PLC is contained within a housing which includes a touch screen LCD screen manufactured by Maple as part HM1530T-006E which serves as an operator interface. Many PLC's are available which will function to control the detection system of the present invention, however, a preferred PLC is manufactured by Keyence and identified as part KV-24 AT. Also included are a monitor and counter screen. The person using this system may utilize the screens to set tolerances for each measurement and location and other options which involve operation of the system and the detection of the side seam gum on the envelope passing through the manufacturing machine. Preferably, the source of radiation is an ultraviolet light source which is directed towards the area of the envelope where the side seam gum is to be located. Typically, the side seam gum is directly below the sensor and the sensor detects the reflection of the ultraviolet light from the side seam gum and the envelope as the envelope passes beneath the sensor. The frequency of the UV reflected from the gum is different from the frequency of the UV reflected from the paper. The reflectivity of the radiation detected by the sensor is then compared to the expected reading which has been inserted by the operator into the PLC which is the frequency range of the UV reflected from the gum. A simple logic program is then used to compare the reflectivity as sensed with the reflectivity as programmed into the system to determine whether or not the measurement is within the parameters as established by the operator. If the measurement is within the parameters or specification then the envelope continues to pass through the system and nothing further occurs. If however the measurement is outside of the specifications, a visual indication is displayed on the PLC screen alerting the operator that an envelope is out of specification and an additional signal is also outputted from the PLC. The additional signal is preferably coupled to an ink jet mounted on the machine and operable to mark the out of specification envelopes with ink. Alternatively, the signal which is generated may be utilized to provide other indicia that the envelope is out of specification such as an audible or visual indication.

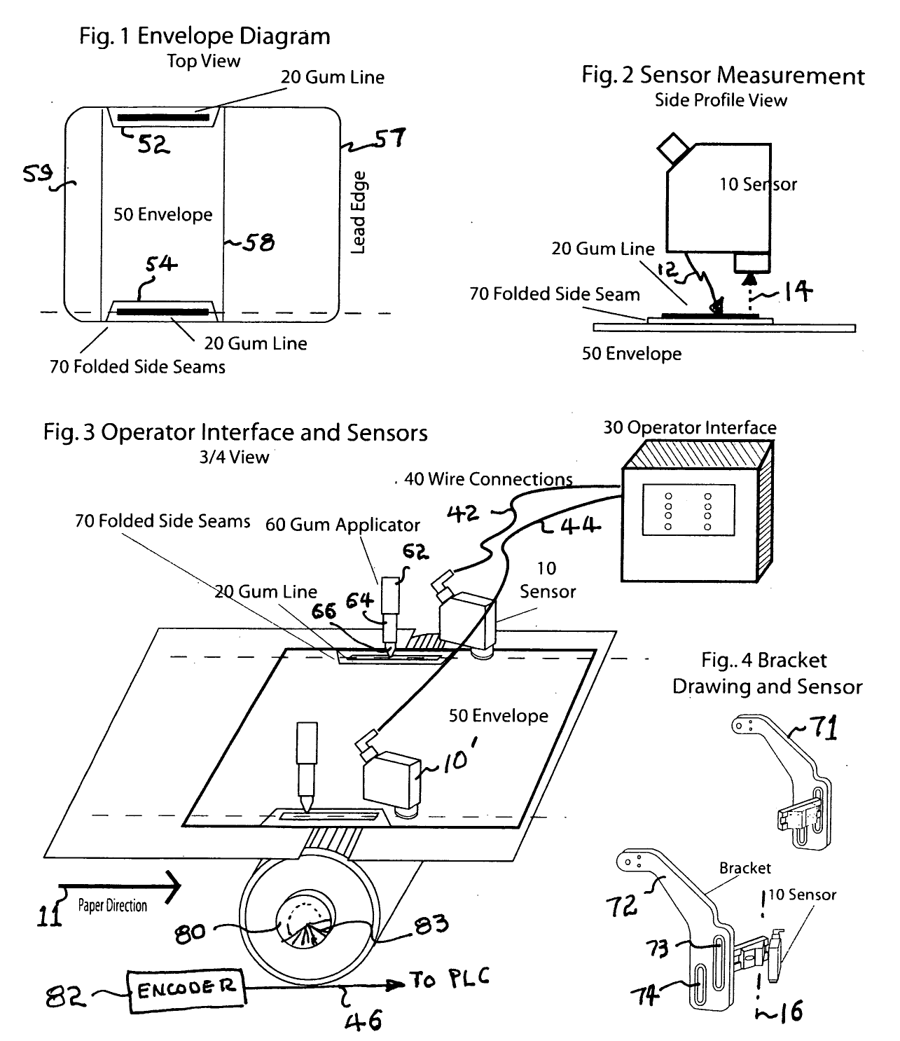

Referring now to the drawings and more particularly to FIG. 1, there is schematically illustrated an envelope 50 which has a pair of side flaps 52 and 54. The envelope also includes a bottom flap 56 which will be folded about the fold line 58 to form the pocket or receiving pouch for the envelope. A top flap 59 will have appropriate adhesive or gum applied thereto so that when contents are placed into the envelope it may be closed and sealed thereby protecting the contents. Also included on the envelope and for purposes of future reference is a leading edge 57 of the bottom flap 56. The leading edge 57 of the envelope 50 is the first portion of the envelope which passes linearly through the envelope manufacturing machine during the gum detection process in accordance with the principles of the present invention. Applied to the side flaps 52 and 54 are gum lines 20 which is a strip of adhesive or gum that is applied to the envelope during the manufacturing process on a continuous inline basis. It is the presence or absence of this gum line 20 as well as where it starts and where it stops and the detection thereof that is the essence of this invention.

As shown in FIG. 2, the invention includes a sensor apparatus 10 which may be any sensor which emits radiation as shown at 12 and can measure the reflection 14 of such radiation from a surface upon which the radiation impacts. In accordance with the preferred embodiment of the present invention the sensor 10 is manufactured by EMX as Model No. UVX-300 G. These sensors emit radiation in the form of ultraviolet light which is then reflected by anything under the sensors. In accordance with the present invention the material under the sensors is the envelope 50 and the gum line 20 as it passes beneath the sensor. The sensor measures the reflectivity of the ultraviolet light around the spectrum of 490 to 530 nanometers. The surface of the envelope reflects ultraviolet light in the spectrum of 430 to 500 nanometers while the side seam gum reflects ultraviolet light in the spectrum of 490 to 530 nanometers. In accordance with a preferred embodiment of the present invention the gum includes an additive to provide the desire frequency spectrum of the U.V. The gum is manufactured by National Adhesives as produce Code 33-349A. The presence of light in the spectrum of 490 to 530 nanometers is detected by the sensor and the signal representative of the intensity is transmitted to a programmable logic controller (PLC) 32 which is shown in FIG. 3 and will be described more in detail below.

By reference now to FIG. 3 the section of the envelope manufacturing system which is used to detect gum on the envelope is schematically illustrated. As is illustrated in FIG. 3 a pair of sensors 10 and 10′ are mounted one on each side of the system and are positioned and adjusted to sense the reflection of the radiation 12 from the envelope 50 and/or the gum lines 20 on the side flaps 52 and 54 as the envelope passes beneath in the direction as illustrated by the arrow 11. Prior to the side seam of the envelope passing beneath the sensors a gumming system 60 applies the gum line to the side flaps 52 and 54 of the envelope 50. The gumming system 60 may be any type of gumming system used in envelope manufacturing which is well known to those skilled in the art. For purposes of schematic illustration the gumming system 60 is shown as a reservoir of adhesive 62 connected by a conduit 64 which is coupled to a dispenser 66 which dispenses the adhesive on the side flaps 52 and 54. The gumming system will be controlled by the manufacturing process to deposit the gum on the flaps 52 and 54 at the desired locations including the beginning and the end of the gum line as well as the amount of gum to be applied. Those skilled in the art will understand and recognize that on occasion the gumming system 60 may malfunction in such a manner that either no gum is applied or that the gum is mislocated on the envelope. It is the purpose of the present invention to detect the gum presence at the desired position on the envelope 50.

The two sensors are mounted to the envelope manufacturing machine and as illustrated disposed downstream from the gumming system 60. The sensors are mounted upon appropriate brackets 71 and 72 as shown in FIG. 4 that will permit adjustment of the sensor vertically and horizontally to meet the specifications set forth by the manufacturer of the sensor. In utilizing the sensor Model No. UVX-300 G in accordance with the preferred embodiment of the present invention the sensors are mounted between 1 inch and 2.5 inches from the top surface of the envelope. It will be understood however that the mounting brackets allow the user to set the sensors at different heights and at different widths apart according to the size of envelope being manufactured. For example, slots 73 and 74 permit vertical adjustment and are spaced apart to permit horizontal adjustment. It should also be understood that the mounting brackets allow the sensors to be rotated about an axis 16 to allow them to occupy less space in the profile view of the envelope manufacturing machine. They may be rotated to any degree desired but in accordance with the preferred embodiment of the present invention they are each rotated approximately 45 degrees with respect to the direction of the paper travel as shown by the arrow 11. The sensors are coupled by way of appropriate coupling members 42 and 44 which may be wire connections 40 to the PLC 32.

The envelope manufacturing machine has appropriate transport mechanisms for transporting the paper in the direction as shown by the arrow 11 and as a part thereof may include a shaft 80. A rotary encoder 82 is disposed adjacent the shaft 80 and is used to determine the relative angle of the shaft 80 as it rotates during the normal use of the machine. The encoder 82 includes an optical sensor mounted near the end of the rotating shaft and optically reflective marks 83 mounted on the rotating shaft inline with the encoder. As the shaft rotates, the encoder will count each reflective mark as it passes as one pulse. Each time the encoder reads the reflective mark at its zero position it will begin counting from zero. In accordance with the preferred embodiment of the present invention utilizing an envelope of the type shown at 50 the encoder is typically counting from zero to 300 during each full rotation of the shaft. The count of the encoder is coupled by appropriate coupling members 46 to the PLC 32 and used in the logic program to determine the position of the envelope. For each positional count received by the PLC from the encoder 82 the program determines if there should be side seam gum on the envelope at that count or not according to the specifications and tolerances set up by the operator in the PLC. If the program determines that there should be side seam gum on the envelope 50 at a given position, then it compares the values given by the sensors to the specifications programmed. If the values for the reflective signal are within the specification for side seam gum at that position then the envelope is within specification and the program continues. If the program determines that the U.V. frequency measurements are out of specification at that position that should have side seam gum or that there is a side seam gum at a position that should not have gum, then the program indicates a fault. The fault signal generated as a result of the out of specification determination generates a signal which may be used to provide an alarm to the operator. In additional there may be provided an ink jet device located at the delivery end of the envelope manufacturing machine and mounted just prior to the collating step thereof. The ink jet device (not shown) is connected to the PLC and when the PLC detects an envelope with seal gum outside of the specification it activates the ink jet device to spray ink on that envelope. The signal is delayed by an amount of envelopes equal to the length of the machine between the sensor and the ink jet sprayer. That delayed time is input by the operator through the PLC at the time the system is initially set up. Envelopes with ink sprayed on them are removed from the rest of the product by the operator.

The shaft 80 with the optically reflective marks mounted thereon may have more than 300 counts in a revolution. When such is the case, when the count reaches the point (for example 300) where the trailing edge of the envelope has passed then the system automatically resets the count to zero which will coincide with the leading edge 57 of the next envelope entering the detection station.

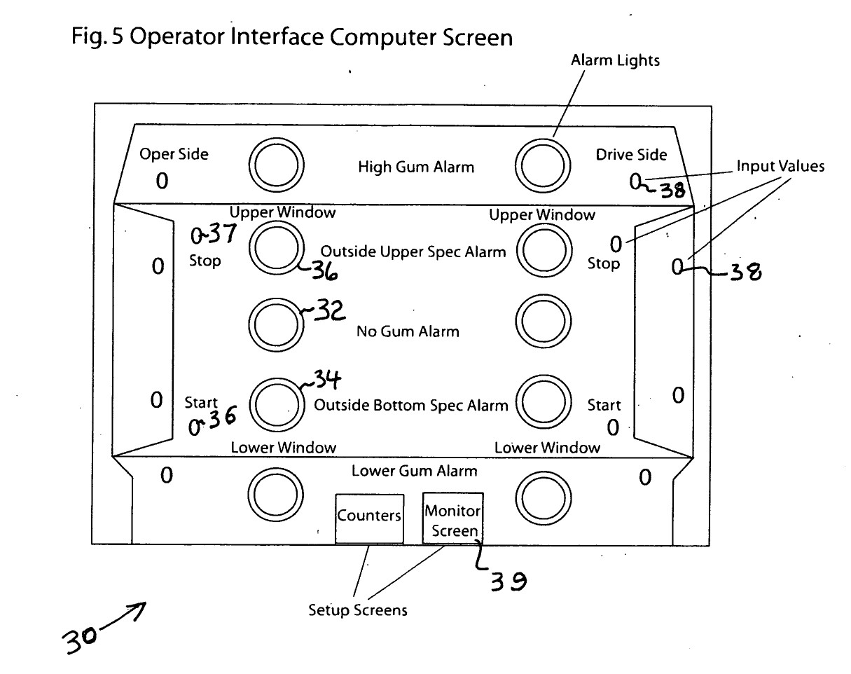

By reference now more particularly to FIG. 5 there is illustrated an operator interface with is used in conjunction with the PLC 32 and the system generally to provide an indication to the operator when the gum detection system operates to determine that the gum is out of specification. If no gum is detected at a particular position on the envelope when the specifications programmed into the PLC 32 indicate that there should be gum then an alarm such as a light 32 would be activated. If the bottom or upper specifications are improper insofar as positioning of the gum is concerned, then alarms such as shown at 34 and 36 would be activated. The operator may when these things occur stop the system by depressing the stop button 37 if such is desired or alternatively if the system has been stopped activate the system again by depressing the start button 36. Appropriate additional operation button screens and the like as are illustrated in FIG. 5 may be used for the purpose of assisting the operator. Additional buttons such as 38 may be used to program the PLC. The monitor or screen 39 is an oscilloscope manufactured by Velleman as a PS 10 PanelScope and is used to display the sensor output and is used during set up and troubleshooting of the system. The operator may adjust the sensor position, output again, or adjust the inputs to the PLC according to the sensor signal displayed.

The gum detection system of the present invention as above described is capable of inline operation at a layer speed of up to 1500 feet per minute during the envelope manufacturing process. The sensors operate continuously and by the ability to detect the reflective radiation provides the ability at operational production speeds to detect an out of specification gum on the envelope and either trigger an alarm or as above indicated spray ink on the out of specification envelopes so that they may be removed.

There has thus been disclosed a system for detecting gum on an envelope and for comparing the position of the gum to preprogrammed predetermined positions on the envelope and when the gum appearing on the envelope is out of specification to provide an appropriate alarm to an operator to remove the out of specification envelopes.

What is claimed is:

1. The method of detecting the presence of gum on an envelope comprising:
(A) directing a source of radiation toward an envelope in the area where gum should be present;
(B) sensing the reflectivity of the radiation from the envelope
(C) comparing the sensed reflectivity to a predetermined desired reflectivity from the gum deposited on said envelope; and
(D) providing an out of specification indicia only when the sensed reflectivity is outside the predetermined desired reflectivity.

2. The method of detecting the presence of gum on an envelope as defined in claim 1 wherein the source of radiation is ultraviolet light.

3. The method of detecting the presence of gum on an envelope as defined in claim 2 wherein the specification for the sensed reflectivity is a frequency between approximately 490 and 530 nanometers.

4. The method of detecting the presence of gum on an envelope as defined in claim 1 including the further step of determining the position of the envelope in an envelope manufacturing system.

5. The method of detecting the presence of gum on an envelope as defined in claim 1 including the further steps of establishing parameters for gum presence, position, and tolerance on an envelope, providing a programmable logic control apparatus, and programming said parameters into said programmable logic control apparatus.

6. An apparatus for detecting the presence of gum on an envelope comprising:
a source of radiation directed toward an envelope in the area where gum should be present;
means for sensing the reflectivity of the radiation from the envelope;
means for comparing the sensed reflectivity to a predetermined desired reflectivity from the gum deposited on said envelope; and
means for generating an out of specification indicia only when the sensed reflectivity is outside the predetermined desired reflectivity.

7. The apparatus as defined in claim 6 wherein said source of radiation is ultraviolet radiation.

8. The apparatus as defined in claim 7 wherein said means for sensing is adapted to sense reflectivity of the ultraviolet radiation at a frequency between approximately 490 and 500 nanometers.

9. The apparatus as defined in claim 6 which further comprises an optical encoder for determining the position of the envelope in an envelope manufacturing system.

10. The apparatus as defined in claim 9 which further includes a programmable logic controller coupled to said means for sensing for providing indicia indicative of an envelope gum being out of specification.
